(19) United States
(12) Patent Application Publication
(10) Pub. No.: US 2017/0254348 A1
(43) Pub. Date: Sep. 7, 2017

(54) METAL JOINT AND MANUFACTURING METHOD THEREFOR

(71) Applicant: Honda Motor Co.,Ltd., Tokyo (JP)

(72) Inventor: Hisayasu OOKA, Saitama (JP)

(73) Assignee: Honda Motor Co.,Ltd., Tokyo (JP)

(21) Appl. No.: 15/437,440

(22) Filed: Feb. 20, 2017

(30) Foreign Application Priority Data
Mar. 3, 2016 (JP) 2016-040962

(51) Int. Cl. F16B 11/00; B32B 7/04; B32B 15/20; B32B 3/28; B32B 37/00; B32B 38/00; B32B 7/08; B32B 15/01

(52) U.S. Cl. CPC F16B 11/004; B32B 7/08; B32B 7/045; B32B 15/017; B32B 3/28; B32B 37/0084; B32B 38/0008; B32B 15/20; B32B 2310/08; B32B 2311/24

(57) ABSTRACT

The present invention provides a method for manufacturing a metal joint that promotes adhesion between metallic joint surfaces to improve joint strength. Pulse lasers are illuminated to at least surface portions, where riveting is to be implemented, of surfaces of metal plates (1), so that the surface portions are molten and solidified to form surface modification thin films (4); and multiple metal plates (1) are stacked to form a laminated metal plate (5) by facing the surface modification thin films (4) to each other, and pressurized shaping is performed on the laminated metal plate (5) by using a punch (7) and a die (6) to implement riveting.

### CROSS-REFERENCE TO RELATED APPLICATION

This application claims the priority benefit of Japan application serial no. 2016-040962, filed on Mar. 03, 2016. The entirety of the above-mentioned patent application is hereby incorporated by reference herein and made a part of this specification.

### BACKGROUND OF THE INVENTION

1. Field of the Invention

The present invention relates to a metal joint and a manufacturing method therefor, and in particular, to a technology that improves joint strength. The metal joint is formed by implementing riveting on multiple metal components to make the metal components bonded with each other.

2. Description of Related Art

As regards technologies that perform joint on multiple metal components, for example, the following technology is known: as disclosed by the background of patent document 1, metal oxide films that exist on joint surfaces of metal components are removed by using a wire brush (wire brush), and the like to make unoxidized metal (fresh surfaces) exposed, and then the metal components are deformed by means of pressure application; micro gaps that exist between the metal components are flattened, so that the exposed fresh surfaces approach to each other until a distance therebetween is reduced to a distance where atomic power can function to perform bonding. The same technology is also disclosed in patent document 2.

In addition, patent document 3 discloses the following technology: when a die is used to implement riveting on metal plates overlapped with each other, a surface of the die is processed into a mirror surface, and therefore, frictional resistance between the die and the metal plates is reduced, so that deformations, such as, flows of the metal plates can be performed smoothly.

### PRIOR ART DOCUMENT

### Patent Document

[Patent document 1] JP Patent Publication No. 2006-150416

[Patent document 2] JP Patent Publication No. H2-25287

[Patent document 3] JP Patent Publication No. 2006-15387

[Patent document 4] JP Patent Publication No. H1-294850

### SUMMARY OF THE INVENTION

### Problems to be Resolved by the Present Invention

However, as disclosed in patent document 1 and patent document 2, in a case in which oxide films are removed by using a wire brush, irregular groove-shaped removing portions are generated. For such local grooves, when metal components are deformed during riveting, a reach to a large depth of the groove indicates a difficult attempt to cause a sufficient plastic flow, and adhesion between materials becomes insufficient, and therefore joint strength is insufficient.

In addition, the subject of the technology disclosed in patent document 3 lies in preventing a shape or size of a metal joint from being deviated, and makes no contribution to improving joint strength.

Generally, in a process of riveted joint between metal plates, in most cases, an area or a joint depth of a joint portion cannot be sufficiently ensured. Due to layout limitation, it is difficult to implement higher joint strength. Therefore, a technology that improves joint strength without enlarging the area or the joint strength of the joint portion is needed.

Therefore, the present invention is directed to provide a metal joint that promotes adhesion between metallic joint surfaces to improve joint strength and a manufacturing method therefor.

### Technical Means for Resolving the Problems

The present inventor, et al., repeatedly carefully research surface modification used to promote adhesion between metallic joint surfaces of metal components to be bonded, and finally conceive of making the metallic joint surface molten and solidified to coarsen crystals and from brittle surface modification layers. In addition, it is found that if the surface modification layers are thin enough, the surface modification layers generate micro cracks due to deformation caused by riveting, and each segmented piece is peeled off starting from the cracks. Therefore, the following conclusion is derived: extremely smooth and unoxidized metal (fresh surfaces) is exposed; because the fresh surfaces are adhered to each other, joint strength is improved.

A method for manufacturing the metal joint of the present invention is provided based on the above derivation, and comprises: illuminating a high energy beam to at least surface portions, where riveting is to be implemented, of surfaces of a plurality of metal plates, wherein the surface portions are molten and solidified to form surface modification thin films; stacking the plurality of metal plates to form a laminated metal plate by facing the surface modification thin films face to each other; and implementing riveting by performing pressurized shaping on the laminated metal plates through a tool.

According to the present invention, high energy beams are illuminated to the surface portions, where riveting is to be implemented, of the surfaces of the metal plates, so that the surface portions are molten and solidified. Therefore, tissues of the surface portions are coarsened to form brittle surface modification thin films. Next, if a tool is used to implement riveting on the laminated metal plates formed by stacking the multiple metal plates in the manner of facing the surface modification thin films to each other, then the surface modification thin films generate micro cracks with deformation of materials, and each segmented piece is peeled off from the cracks, and extremely smooth fresh surfaces are exposed in a large range. Because the fresh surfaces are adhered to each other, strong joint strength can be obtained. In addition, because layers with extremely small depths of the metal plates are modified, strength of a base material is not affected.

To practically obtain the foregoing function and effect, an ideal thickness of a metal plate is less than 3 mm, and an ideal thickness of a surface modification thin film is less than 1/10 of the thickness of the metal plate. More specifically, the ideal thickness of the surface modification thin film is 5 μm to 100 μm. By setting the thickness of the surface modification thin film to be greater than 5 μm, in a case in which a material is aluminum, and the like, the surface modification thin film can be practically modified (embrittled) into a metal oxide film; in a case in which the material is stainless steel, the surface modification thin film can be practically modified (embrittled) into a passivated film.

On the other aspect, if the thickness of the surface modification thin film exceeds 100 μm, the surface modification thin film can be hardly cracked by means of riveting. In addition, even the surface modification thin film is cracked, the surface modification thin film is coarsely segmented, and therefore can be hardly peeled off, so that a fresh surface cannot be sufficiently exposed. In other words, by setting the thickness of the surface modification thin film to be less than 100 μm, during riveting, the surface modification thin film generates micro cracks, and each segmented piece is peeled off starting from the cracks, and therefore a large piece of fresh surface can be obtained. Therefore, because large-area adhesion is performed, joint strength can be improved.

Further, patent document 4 discloses a technology that a high energy density beam is illuminated to a surface of a high-temperature aluminum continuous casting block to perform surface modification. This technology is a technology that generates a compound secondary phase or implements grain micronization by using rapid solidification (rapid solidification) of the surface of the aluminum continuous casting block, so as to improve surface attributes, for example, etching resistance, corrosion resistance, impact resistance, or fatigue resistance, and therefore is a technology different from the present invention in which an embrittled surface modification thin film is formed. Differences between the present invention and patent document 4 are described in detail in subsequent embodiments.

Further, ideally, a pulse laser is used as a high energy beam. Heat output to a metal surface can be controlled by using the pulse laser to make only an extremely thin surface molten and solidified to form a thin and brittle surface modification thin film. Therefore, even a plastic deformation quantity generated by riveting is small, the surface modification thin film is also practically cracked; a segmented piece is peeled off starting from the cracks, so as to make fresh surfaces exposed in a large ranged. In addition, because the fresh surfaces are adhered to each other, joint strength can be improved.

In addition, for example, metal materials, such as aluminum, iron, copper, titanium, and magnesium, and alloys of the metal materials can be used as materials of the metal plates.

Second, the metal joint of the present invention includes a laminated metal plate formed by stacking a plurality of metal plates with each other, wherein a recess is formed on a surface of the laminated metal plate, a protrusion is formed on another surface of the laminated metal plate by protruding a recessed portion of the recess, and surface modification thin films brittler than other parts are formed on surfaces opposite to each other of the metal plates, and in the recess, fresh surfaces exposed due to peeling off of a part of the surface modification thin films are adhered to each other.

According to the metal joint of the present invention, because the fresh surfaces formed due to peeling off of a part of the surface modification thin films are adhered to each other, strong joint strength can be obtained.

### Effects of the Present Invention

According to the present invention, brittle surface modification thin films are formed on joint surfaces of metal plates; the surface modification thin films are peeled off by means of processing to promote fresh surfaces to be adhered to each other, and therefore, effects, such as improving joint strength without enlarging an area or a joint depth of a joint portion can be obtained.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of state in which surface modification of a surface of a metal plate is performed by means of a pulse laser.

FIG. 2 is a cross-sectional view of state in which riveting is implemented on laminated metal plates formed by overlapping metal plates after surface modification.

FIG. 3(A) is a photo obtained by photographing a surface of a rolled material at a magnification of 100. FIG. 3(B) is a photo obtained by photographing the surface of the rolled material at a magnification of 500.

FIG. 4(A) is a photo obtained by photographing a surface of a metal plate after surface modification at a magnification of 100. FIG. 4(B) is a photo obtained by photographing the surface of the metal plate at a magnification of 500.

FIG. 5(A) is a photo of a surface of a rolled material before a V-shaped bending test. FIG. 5(B) is a photo of a surface of a bending portion of the rolled material after the V-shaped bending test.

FIG. 6(A) is a photo of a surface of a metal plate after surface modification before a V-shaped bending test. FIG. 6(B) is a photo of a surface of a bending portion of a metal plate after the V-shaped bending test.

FIG. 7 is a cross-sectional view of a processed laminated metal plate in an embodiment.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### 1. Surface Modification Processing

An implementation manner of the present invention is described below with reference to the accompanying drawings. FIG. 1 indicates state in surface modification processing is implemented on a metal plate 1, for example, an aluminum plate. A metal oxide film 2 is formed on a surface of the metal plate 1. When a pulse laser 3 is illuminated to a surface of the metal plate 1, the pulse laser 3 is scanned. Therefore, the metal oxide film 2 is made molten and solidified and surface modification is performed on the metal oxide film 2 to form a surface modification thin film 4. In this case, surface modification is performed seamlessly on a whole surface of a part in which riveting is subsequently implemented. The surface modification thin film 4 is a brittle tissue that includes coarse crystals.

### 2. Riveted Joint

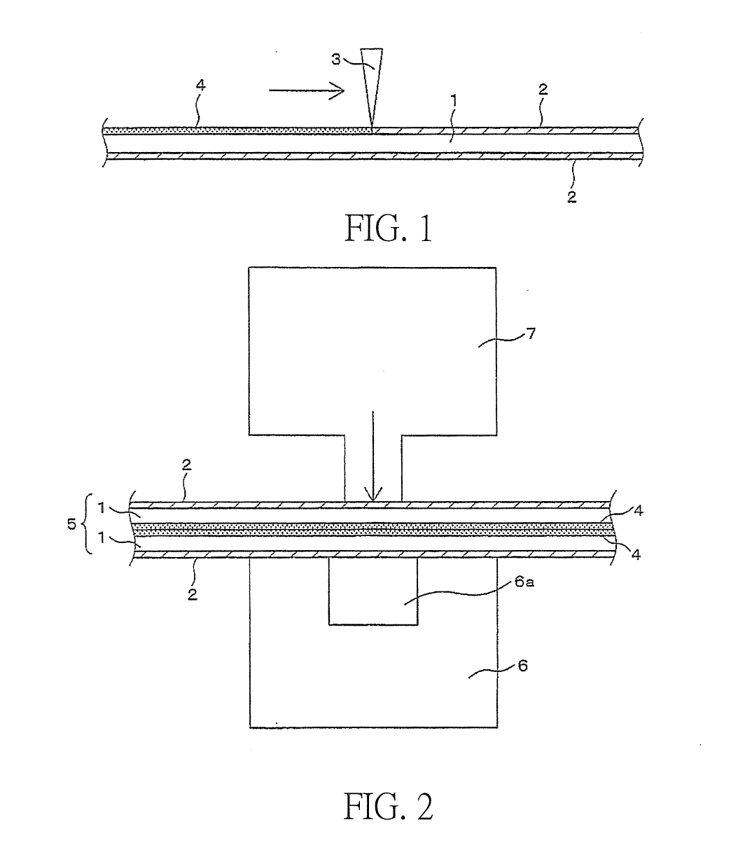

Second, as shown in FIG. 2, two metal plates 1 are made overlapped to form a laminated metal plate 5 in a manner of making the surface modification thin films 4 face each other. Pressurized shaping is performed on the laminated metal plates 5 by means of a die 6 with a circular cross section and a recess 6a, and a punch 7 with a circular cross section. The punch 7 can approach to or get far away from the die 6 by means of a driving mechanism not shown in the drawing. A diameter of a front end portion of the punch 7 is a diameter less than that of the recess 6a of the die 6.

If the punch 7 is moved to a side of the die 6, then the laminated metal plate 5 perform plastic deformation in a manner of protruding downwards. In this case, because the surface modification thin films 4 are brittle, the surface modification thin films 4 generate micro cracks due to deformation of the laminated metal plate 5; each segmented piece is peeled off starting from the cracks; and fresh surfaces of the metal plates 1 are exposed in a large range. Next, the fresh surfaces are adhered to each other due to pressure applied to the fresh surfaces. Therefore, compared with the prior art in which metal oxide films on surfaces are removed by using a wire brush, and the like disclosed in patent document 1 and patent document 2, the technology of the present invention can lead to adhesion in a larger range so as to obtain stronger joint strength.

In particular, in the implementation manner, the pulse laser 3 is used as a high energy beam, and therefore heat output to surfaces of the metal plates 1 can be controlled to make only extremely thin surfaces molten and solidified to form thin and brittle surface modification thin films. Therefore, even plastic deformation generated by riveting is small, the surface modification thin films 4 are also practically cracked; segmented pieces are peeled off starting from the cracks, so as to make the fresh surfaces exposed in a large ranged. In addition, because the fresh surfaces are adhered to each other, join strength can be improved.

Further, in the implementation manners, riveted joint can be performed on the laminated metal plate 5 that includes two metal plates 1, and can also be performed on the laminated metal plate 5 that includes three or more metal plates 1. In this case, surface modification is performed by means of the pulse laser 3 on all surfaces that face each other of the metal plates 1.

### Embodiments

### 1. Embodiment 1 (Surface Modification Processing)

The present invention is described below in more detail with reference to an embodiment.

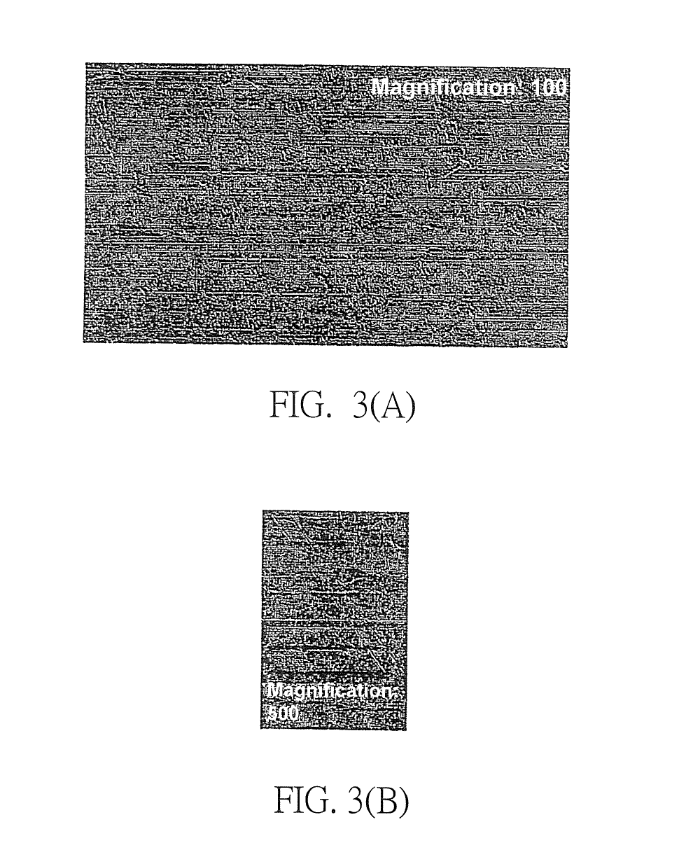

FIG. 3 is a photo of a surface of an aluminum (an aluminum alloy manufactured by KOBE STEEL LTD: 6K21) rolled material with a thickness of 1 mm. FIG. 3(A) is a photo photographed at a magnification of 100. FIG. 3(B) is a photo photographed at a magnification of 500. As shown in the drawings, micro traces of a rolling roller remain on the surface of the rolled material.

Second, a pulse laser apparatus (manufactured by Clean Laser System Company; power: 120 W; focal distance: 150 mm; pulse frequency: 10 kHz; scan frequency: 50 Hz) is used to perform surface modification on the rolled material. Pulse laser scanning is performed seamlessly on a whole surface of a local part of the rolled material.

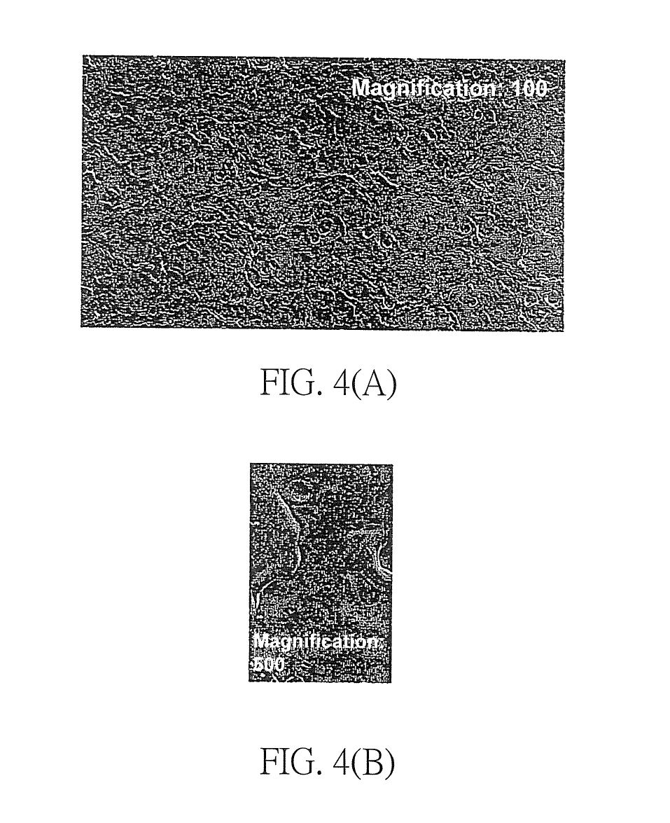

FIG. 4 is a photo of a surface of a metal plate after surface modification is performed under the condition. FIG. 4(A) is a photo photographed at a magnification of 100. FIG. 4(B) is a photo photographed at a magnification of 500. According to FIG. 4(A), it is known that scanning is performed seamlessly by using a pulse laser. In addition, according to FIG. 4(B), it is known that the surface of the rolled material is molten and solidified; the traces of the rolling roller disappear, and the surface becomes smooth. That is, formation of a surface modification thin film is confirmed. An average thickness of the surface modification thin film is 7 μm.

### 2. Embodiment 2 (V-Shaped Bending Test)

According to Japanese Industrial Standards (JIS) Z2248, a V-shaped bending test is performed on the rolled material and the metal plate after surface modification. The V-shaped bending test is the following test, that is, making a male die and a female die that have a press surface bent into a V shape at a specified angle sandwich a sample to bend the sample. In the V-shaped bending test of the metal plate, a part after surface modification is located at an angular side of the V shape.

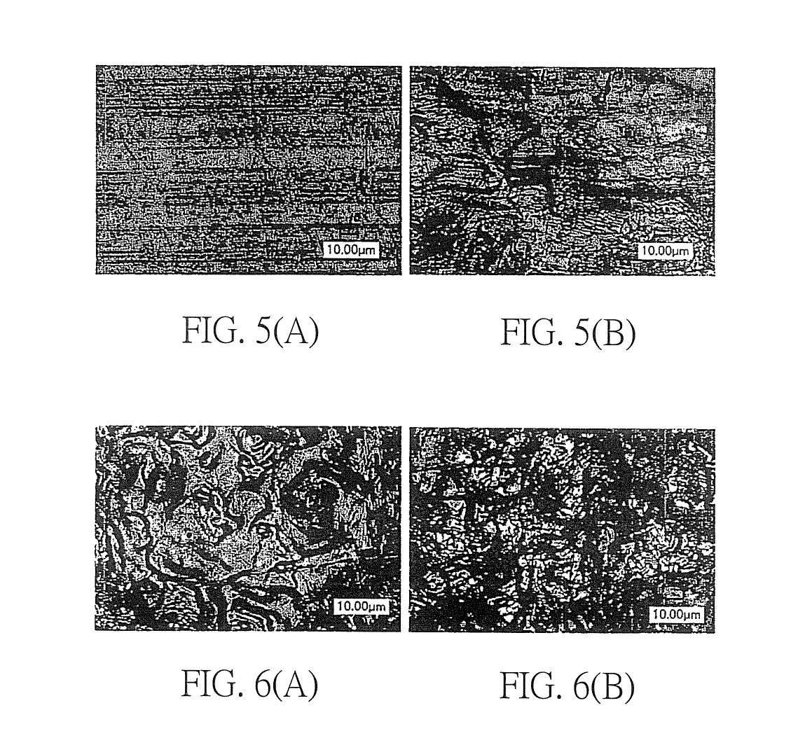

FIG. 5(A) is a photo of a surface of a rolled material before a V-shaped bending test. FIG. 5(B) is a photo of a surface of a bending portion of the rolled material after the V-shaped bending test. As shown in FIG. 5(B), large cracks of a metal oxide film are seen on the surface of the bending portion of the rolled material.

On the other aspect, FIG. 6(A) is a photo of a surface of a metal plate after surface modification before a V-shaped bending test. FIG. 6(B) is a photo of a surface of a bending portion of a metal plate after the V-shaped bending test. As shown in FIG. 6(B), a large quantity of micro cracks of a surface modification thin film are seen on the surface of the bending portion of the metal plate. Therefore, it is derived that if riveting is performed on the foregoing metal plates, then the surface modification thin films generate micro cracks, and each segmented piece is peeled off starting from the cracks, and fresh surfaces are exposed in a large range. Upon comparison, it is derived that it is difficult to peel off each segmented piece of a rolled plate on which surface modification is not performed because cracks of metal oxide films are large. This case also applies to the technology disclosed in patent document literature 4.

In addition, in patent document literature 4, surface modification is performed on an aluminum ingot by using a tungsten insert gas (TIG) arc welding. This technology is to cast an ingot with a thickness of more than 300 mm, and then cool to 200° C., and make a whole surface molten by means of the TIG arc welding. Then, a trace of alloy elements is added into the molten surface, and therefore a molten tissue is micronized. Or, a shield gas (shield gas) during melting is made to contain oxygen or nitrogen, and therefore an oxide or a nitride is generated to improve abrasion resistance. A thickness of a surface modification layer in this technology is about 1/10 to 1/100 of that of the ingot. Therefore, for the technology in patent document 4, because a tissue of the surface modification layer is micro and hard, and the surface modification layer is thick, in the V-shaped bending test, the surface modification layer is not easily cracked, and therefore it is derived that when riveting is implemented, it is difficult to peel off the surface modification layer.

Further, for the present invention, if in a surface modification process, a pulse laser is repeatedly scanned, then the thickness of the surface modification thin film is increased, and consequently, a problem the same as in patent document 4 is also generated. Therefore, ideally, the pulse laser is scanned seamlessly without increasing the thickness, and therefore, the thickness of the surface modification thin film is set to be less than 100 μm.

### 3. Embodiment 3 (Riveted Joint)

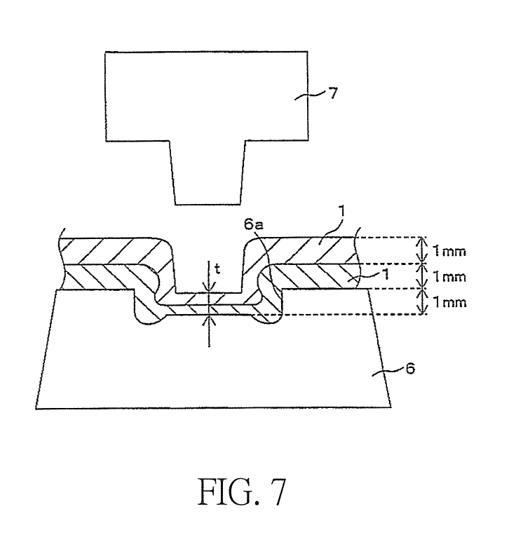

Metal oxide films of single surfaces of the rolled material used in Embodiment 1 are removed by using a wire brush, and two rolled materials are made overlapped to form laminated metal plate in a manner of making the surfaces face each other. In addition, two metal plates are made overlapped to form laminated metal plates in a manner of surface facing of surface modification performed in Embodiment 1. In this case, the rolled materials and the metal plates are set to be reed-shaped, and the rolled materials and the metal plates are staggered from each other to form laminated metal plates. A riveting apparatus (manufactured by TOX company) shown in FIG. 7 is used to shape the laminated metal plate into a shape shown in FIG. 7, and riveted joint is performed. The riveting apparatus is an apparatus having the following structure, that is, a die 6 with a recess 6a, and a punch 7, and the punch 7 is made to approach or far away from the die 6. A lower low-lying part is Mimed on a periphery of a bottom part of the recess 6a, so that material of the shaped laminated metal plate enters the low-lying part and riveting shaping is performed on a boundary portion of the materials by means of engagement.

A diameter of the punch 7 for riveted joint is set as 5.6 mm; a diameter of the die 6 is set as 8 mm; and a depth of the recess 6a of the die 6 is set as 1.0 mm. In addition, a location of a bottom dead center of the punch 7 is adjusted, so that a plate thickness t after the punch 7 is pressed into the laminated metal plate reaches 0.9 mm to 1.4 mm. Shear strength of each laminated metal plate of each pressed plate thickness tis indicated in Table 1. Further, a tensile test is performed on a separation direction of two end portions of the laminated metal plate which are riveting shaped is performed, so as to measure the shear strength.

TABLE 1

| | | Pressed plate | | | |
|---|---|---|---|---|---|
| | | thickness (mm) | | | |
| | | 0.9 | 1 | 1.2 | 1.4 |
| Shear strength (kN) | Example of the present | 2.35 | 2.13 | 1.46 | 1.16 |
| | invention | | | | |
| | Existing example | 2.04 | 1.27 | 1.01 | 0.00 |

If a press degree of the punch 7 is increased, then a press amount is increased, and the pressed plate thickness is reduced. On the contrary, if the pressed plate thickness is increased, then pressurization performed by the punch is insufficient, and a riveting shaping portion cannot be completely shaped. Compared with the existing example, in the example of the present invention, a press depth and the shear strength are both higher. When the pressed plate thickness is 1.4 mm, for the existing example, the riveting shaping is insufficient, and the laminated metal plates 1 are not adhered to each other, and therefore, the shear strength is not reflected. However, for the example of the present invention, in a bottom surface area wrapped and sandwiched between the punch 7 and the die 6, fresh surfaces are adhered, and therefore, the shear strength is reflected.

In this way, in the existing example in which oxide films are removed by using a wire brush, during processing, a reach to a large depth of a groove formed by the wire brush indicates a difficult attempt to cause a sufficient plastic flow, and adhesion between materials becomes insufficient, and joint strength is insufficient. Upon comparison, in the example of the present invention, as shown in Embodiment 2, the surface modification thin films generate micro cracks, and each segmented piece is peeled off starting from the cracks, and flat fresh surfaces are exposed in a large range. Therefore, adhesion is easy during deformation, and as a result, a large adhesion area can be ensured to improve joint strength.

Further, for the technology disclosed in patent document 4, because the thickness of the surface modification layer is large, it is not considered that the surface modification layer is made to generate micro cracks by means of riveted joint as in the example of the present invention, and therefore, it is derived that the obtained shear strength is equal to or less than that of the existing example.

### Industrial Applicability

The present invention can use a technology that performs riveting on multiple metal plates to make the metal plates jointed, and is, in particular, applicable to usage when an area or a depth of a joint portion is limited.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A metal joint, comprising a laminated metal plate formed by stacking a plurality of metal plates with each other, wherein a recess is formed on a surface of the laminated metal plate, a protrusion is formed on another surface of the laminated metal plate by protruding a recessed portion of the recess, and surface modification thin films brittler than other parts are formed on surfaces opposite to each other of the metal plates, and in the recess, fresh surfaces exposed due to peeling off of a part of the surface modification thin films are adhered to each other.

2. A method for manufacturing a metal joint, comprising:
illuminating a high energy beam to at least surface portions, where riveting is to be implemented, of surfaces of a plurality of metal plates, wherein the surface portions are molten and solidified to form surface modification thin films;
stacking the plurality of metal plates to form a laminated metal plate by facing the surface modification thin films to each other; and
implementing riveting by pertaining pressurized shaping on the laminated metal plate through a tool.

3. The method for manufacturing a metal joint according to claim 2, wherein the high energy beams are pulse lasers.
